(19) United States
(12) Patent Application Publication
(10) Pub. No.: US 2004/0219284 A1
(43) Pub. Date: Nov. 4, 2004

(54) Poultry roast

(76) Inventor: John J. Bruno, Alpharetta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/426,676

(22) Filed: Apr. 30, 2003

(51) Int. Cl. A23L 1/31

(52) U.S. Cl. 426/644

(57) ABSTRACT

A prepared poultry roast is formed by placing one or more chicken tenders on the inner, skinless surface of a butterfly cut of poultry breast, and wrapping the breast around the tender so that the skin of the breast faces the outside and becomes a protective envelope for the roast. The roast is gathered in a net that holds the roast together. The skin of the roast protects the meat from becoming hard and dry when the roast is cooked in a microwave oven.

### FIELD OF THE INVENTION

This invention concerns a prepared roast of poultry breast meat that is of a predetermined weight that can be cooked at a specified temperature for a specified time.

### BACKGROUND OF THE INVENTION

In recent years, consumers of prepared frozen meals have become accustomed to being able to read the directions on the box containing the meal and following the instructions concerning the temperature and time for preparing the meal in a microwave oven. The preparation of the meal is convenient and can be performed by an unskilled cook. The public has now become used to the rapid and skill-free preparation of food in microwave ovens.

However, when poultry, such as parts of an oven ready bird, are cooked in a microwave oven, the exposed surface of the poultry meat tends to become hardened and dried out for about ⅛ of an inch in thickness. While some of the meat might be covered by the skin of the bird and not damaged by the cooking process, the other exposed surfaces tend to become dried and tough. When the person that is to eat the bird detects that the cooked product has become hardened on the exterior, the person tends to believe that the bird is old or otherwise defective.

Also, poultry parts are not all the same size and some might have the bone still in the meat and others not, so that the time required to cook the meat is variable and difficult to determine. Thus, the poultry industry has not developed a successful uniform poultry product that can be cooked for a predetermined time in a microwave oven.

It is to the above noted aspects of the prior art that this invention is directed.

### SUMMARY OF THE INVENTION

Briefly described, the present invention comprises a prepared roast formed of poultry parts, particularly of the deboned breast of poultry, and the process for making the poultry roast, whereby the roasts are of substantially the same weight so that each roast can be cooked in a microwave oven for a specified time at a specified temperature.

Whole birds are received from a processing line in oven ready configuration, The wings and legs of the birds are removed from the carcass and the breast and its skin are stripped away from the underlying skeletal structure. This leaves a pair of breast tenderloins, known in the industry as “chicken tenders” that reside beneath the breast that are still attached to the skeletal part of the bird. The tenders are also stripped away from the skeletal structure. The poultry breast is in the configuration of a butterfly cut having meat with an outer surface still covered by the poultry skin and an inner surface that is skin free. The cut made in the poultry carcass is formed to maximize the amount of skin remaining with the breast, without taking too much skin from the adjacent parts of the bird.

In order to form the prepared poultry roast at the desired “predetermined” weight, one or more poultry tenders is added to the breast to increase the cumulative weight of the roast to the desired weight. For example, a chicken tender is an elongated, bone-free strip of white meat that typically weighs between 1½ oz. and 3 oz. and of a length of 3/4 inch to 1/12 inches and diameter of ¾ to 1¼ inches. The chicken tender is placed on the skinless inner surface of the poultry breast, aligned with the longitudinal skeletal recess of the breast. The side portions of the breast are rolled over the chicken tender, usually in a spiral roll configuration, so that the chicken tender is completely enclosed inside the breast, and the skin of the breast is substantially completely wrapped around the meat of the breast and the chicken tender.

During the process of forming the roast, the parts of the roast can be seasoned by sprinkling lemon herb, rosemary, Italian, or other special recipe flavoring on the skinless surface of the breast and on the chicken tenders. Ultimately, this provides enhanced taste to the interior of the roast after it has been cooked in a microwave oven.

The rolled up roast of chicken breast and chicken tenders is then placed in a net or other type girdle that holds the breast in its rolled up configuration. The net is drawn tight about the roast, tending to form the roast in an oval configuration.

In order to meet the predetermined weight specifications for the poultry roast, the number and size of chicken tenders added to the breast can be varied. For example, one or more chicken tenders can be added to the breast, or the chicken tenders can be divided in half and half of a chicken tender can be added to the breast or matched with one or more whole chicken tenders to accurately achieve the desired weight. The addition of chicken tenders also increases the size of the poultry roast, so that the roasts prepared in this manner will not only be approximately the same weight, but also approximately the same size, and of a large enough size that is suitable for cooking as a roast for multiple servings, and the uniform weight of the roasts made in this manner can be cooked for a specified period in a microwave oven.

Moreover, by placing the skin of the breast on the outside of the rolled poultry roast, the tendency of the microwave action to dry out poultry products will be concentrated primarily only on the skin, leaving the meat beneath the skin moist and tender.

Thus, it is an object of this invention to provide an improved poultry product that can be cooked in a microwave oven and provide an acceptable, moist and tender meat product.

Another object of this invention is to provide a prepared poultry roast that has the skin of the bird wrapped around the meat and prepared at a predetermined weight for uniform instructions for cooking in a microwave oven. Another object of this invention is to provide a poultry roast that is seasoned interiorly of the meat and which combines a poultry breast with poultry tenders wrapped in the breast.

Another object of this invention is to provide an improved poultry product that can be successfully cooked in a microwave oven.

Another object of this invention is to provide poultry roasts of uniform weight for cooking at a specified time and temperature in a microwave oven.

Other objects, features, and advantages of the present invention will become apparent upon reading the following specification, when taken in conjunction with the accompanying drawings.

### BRIEF DESCRIPTION OF THE DRAWINGS

FIG. 1 illustrates a poultry breast removed from the skeletal structure of the bird, showing the skin free inner surface of the breast.

FIG. 2 is a side view of the poultry breast of FIG. 1, taken along lines 2-2 of FIG. 1.

FIG. 3 is an end view of the poultry breast, taken along lines 3-3 of FIG. 1.

FIG. 4 illustrates a chicken tender.

FIG. 5 illustrates a chicken tender, showing how the tender can be cut longitudinally to form tenders of reduced size.

FIG. 6 shows the poultry breast of FIG. 1, and a chicken tender placed on the skin free inner surface of the breast.

FIG. 7 is a side view of the poultry breast and tender of FIG. 6, taken along lines 7-7 of FIG. 6.

FIG. 8 is an end view of the poultry breast and tender of FIG. 6, taken along lines 8-8 of FIG. 6.

FIG. 9 is an end view of the poultry breast and tender of FIG. 6, showing how the poultry breast is wrapped around the chicken tender.

FIG. 10 is perspective view of the poultry roast as it enters the open-ended shaping cone for wrapping in a net.

FIG. 11 is a perspective illustration of the poultry roast as it emerges from the shaping cone and is gathered in the net.

FIG. 12 shows the poultry roast after the net has been closed about the roast.

FIG. 13 shows the poultry roast of FIG. 12, illustrating the injection of fluid in the roast.

### DETAILED DESCRIPTION

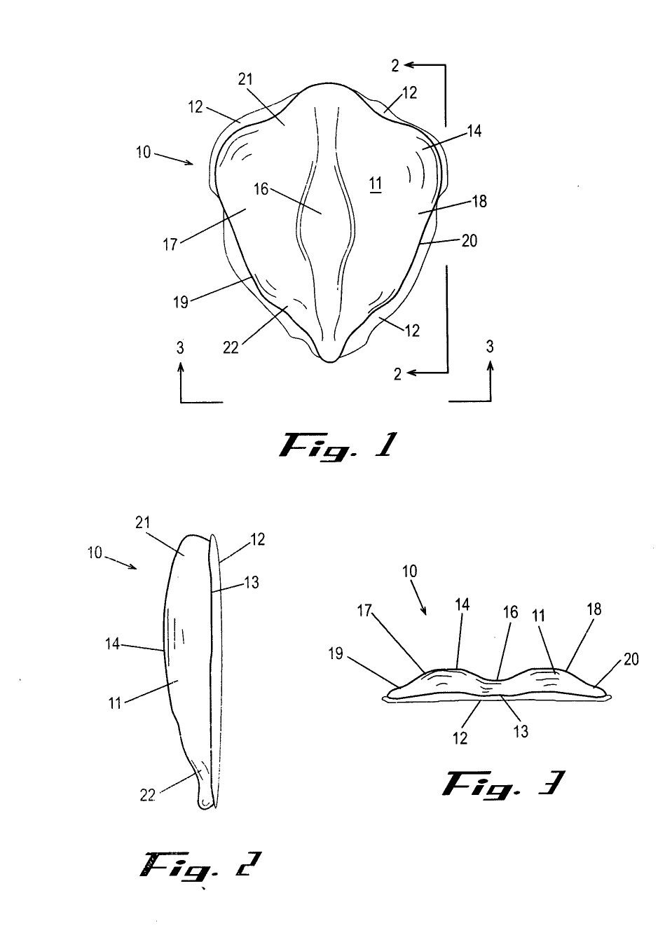

Referring now in more detail to the drawings, in which like numerals indicate like parts throughout the several views, FIG. 1 illustrates a deboned poultry breast 10 in the form of a butterfly cut. The poultry breast includes meat 11 and skin 12. The skin covers the outer surface 13, with the opposed inner surface 14 being skinless. The breast has a skeletal recess 16 formed along the length of the breast, with breast halves 17 and 18 straddling the skeletal recess 16.

As illustrated in FIG. 2, the poultry breast 10 is tapered along its length with one end 21 being thicker and the other end 22 being thinner. Also, as shown in FIG. 3, the breast is somewhat thicker at its central portion about the skeletal recess 16 than it is near its side edges 19 and 20.

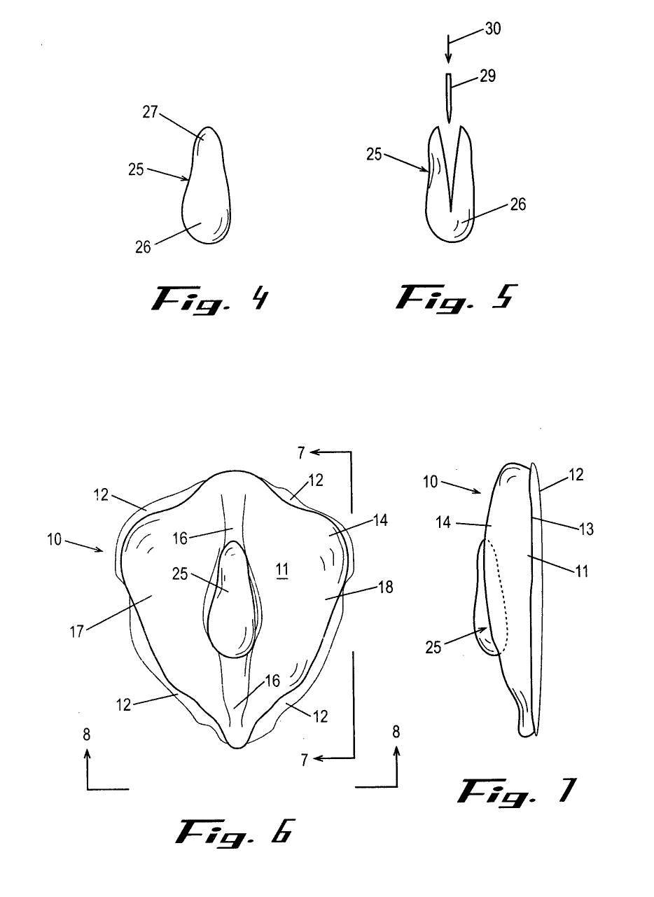

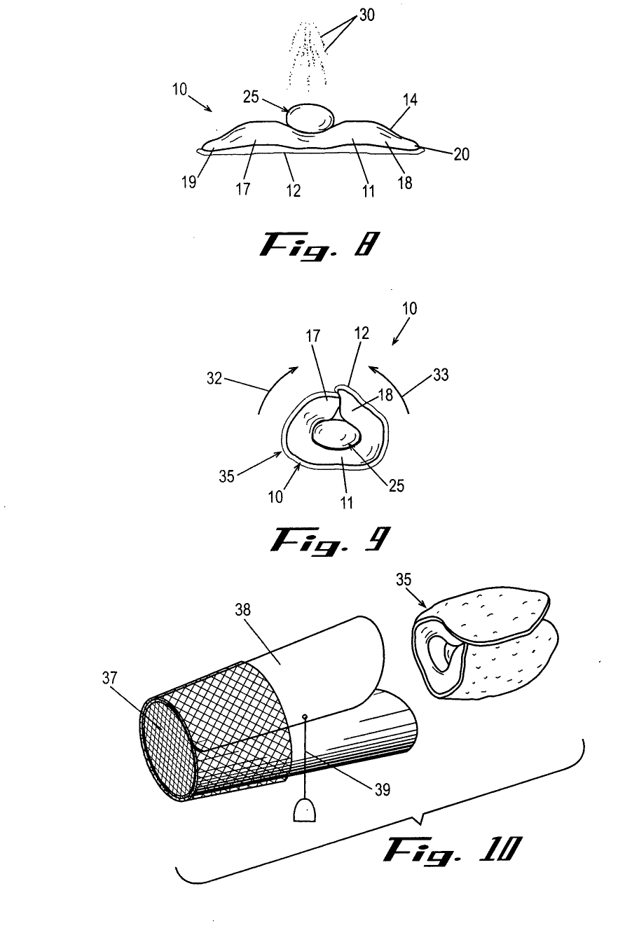

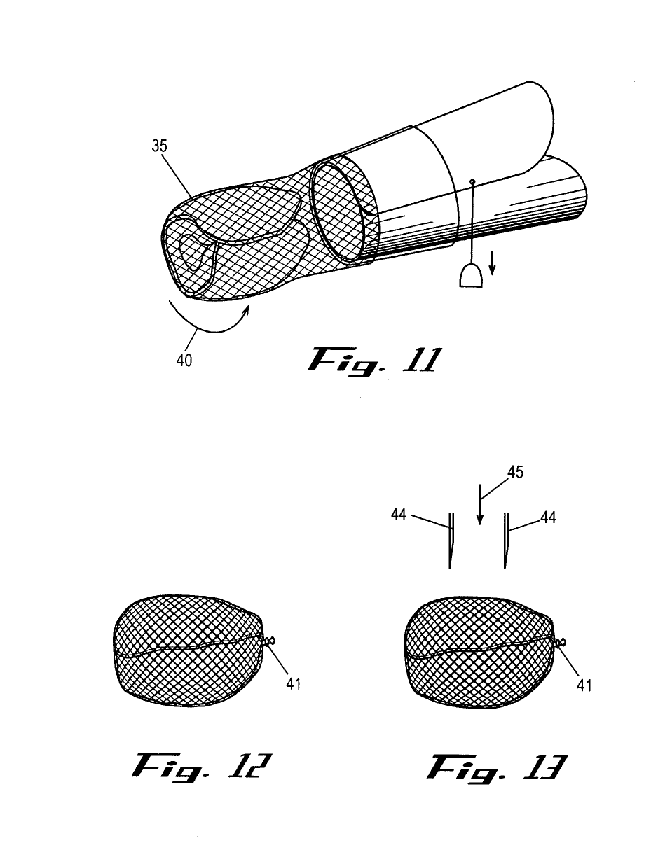

FIGS. 4 and 5 illustrate a chicken tender 25 that is to be added to the poultry breast 10. The chicken tenders usually are tapered along their length, having a thicker end portion 26 and a thinner end portion 27. In some instances, the chicken tenders 25 will be reduced in size, as by cutting the tender longitudinally, as illustrated by the knife 29 moving in the direction indicated by arrow 30, cutting the tender in halves.

As illustrated in FIG. 6, one or more chicken tenders 25 are placed on the inner, skinless surface 14, with the length of the tender placed parallel to and juxtaposed the elongated skeletal recess 16 of the poultry breast. The thicker end portion 26 of the tender usually is placed adjacent the thinner end portion 22 of the breast, so that the cumulative thickness of the breast and tender are more uniform along the length of the breast and tender.

Poultry breasts of chickens usually weigh from about 20 ounces to about 30 ounces. If it is desired to make poultry roasts from the breasts of chickens that each weigh 23 ounces for sale in the supermarket and the available breasts weigh from approximately 20 to 22 ounces, two tenders weighing a total of 4 ounces can be added to the breasts that weigh 20 ounces and one tender weighing 1 ounce can be added to the breast that weighs 21 ounces to reach the desired cumulative weight of 23 ounces for each roast. If the poultry roasts are to be sold for consumption at large eating facilities where masses of people are to be served, the roasts, such as 33 ounce roasts are likely to be formed by the larger breasts and tenders, such as 30 ounce breasts and one or more tenders weighing 3 ounces to make the cumulative weight of 33 ounces.

As illustrated in FIG. 8, seasoning 30 can be added to the skinless inner surface 14 of the breast and the chicken tender 25.

FIG. 9 illustrates the poultry roast 10 being formed by wrapping the breast halves 17 and 18 about the chicken tender 25. If the breast halves are long enough to overlap each other, they usually will be spirally formed about the tender. The skin 12 will be stretched as available for covering all of the meat 11, so as to attempt to provide an envelope of skin that extends about the entire breast meat and tender. This is desirable so that when the roast is placed in a microwave oven, the skin protects the interior meat from becoming dried and crusty.

The breast halves 17 and 18 are wrapped as indicated by arrows 32 and 33 about the chicken tender 25. This forms the breast and tender in the form of a prepared poultry roast 35.

Once the poultry roast has been formed as illustrated in FIG. 9, it is to be placed in a net 37 or other girdle that retains the poultry roast in its prepared configuration. The net 37 is in the form of a sock, having an open end, and the open end of the net is placed about a shaping cone 38. The poultry roast 35 is moved into the larger end of the shaping cone 38, on through the shaping cone until it engages the net 37. As the poultry roast moves through the shaping cone, it is compressed by the converging side wall of the shaping cone. The shaping cone is formed in a spiral so that its diameter can be reduced or enlarged as may be desired. A tether 39 is attached to the shaping cone so as to allow the operator to reduce the size of the shaping cone during the netting process. The poultry roast is squeezed to a smaller breadth as it emerges from the other end of the shaping cone 38 and moves into the net 37. The net becomes wrapped around the poultry roast, and when the roast emerges from the shaping cone, the roast and its net are rotated as indicated by arrow 40 so as to reduce the trailing part of the net into a spiral closure, and a permanent clamp 41 is applied to the end of the net, which closes the net about the poultry roast.

If desired, the taste of the poultry roast can be enhanced by injecting taste fluids into it, as illustrated in FIG. 13, by injectors 44 being thrust into the poultry roast as indicated by arrow 45.

Net 37 is soaked in a liquid prior to being filled with the poultry roast so as to keep the net moist during the cooking of the roast, and to add moisture to the skin of the roast as the skin tends to become dry during the cooking process. The soaking of the net also keeps the net more flexible for removal when the roast has been cooked. The liquid in which the net is soaked can include a seasoning to add to the flavor of the cooked roast. The open weave of the net allows the purchaser to view the roast before purchase, and allows the skin of the roast to become better by the cooking process.

The uniform weight of the roasts prepared by this procedure allows the producer to provide prepared and specific cooking instructions with all of the products, that instruct the purchaser to cook the roast for a specific time in a microwave oven. The customer does not have to guess what the cooking time will be for the roast, does not have to be an experienced cook to prepare the meal, and can attend to other activities without having to watch the cooking of the roast. The producer of the roasts can deliver the roasts to the retail merchant in packages of two or more of the roasts, all of the same weight and with identical cooking instructions for each roast. The purchaser can take the package of roasts home and cook one or more of the roasts and freeze the remaining roasts for future consumption. The retail merchant does not have to prepare the roast or otherwise handle the product except for pricing the product and putting the package in the refrigerated display case. The purchaser can slice the roast into layers when the cooked roast is to be served, with the chicken

While the poultry roast has been disclosed as being made of breast of chicken and chicken tenders, the roasts can be made of other poultry species, such as turkeys, guineas, and other species that have the breasts and tenders as described.

Moreover, roasts can be made using the same principles as described, but substituting or adding other fillers for the chicken tenders, such as edible items as pork, beef, vegetables, fruits and seasoning, and with similar items that impart shaping to the roast, including edible and non edible items.

While the invention has been described as enabling the consumer of the roast to cook the roasts in a microwave oven, the roasts can be cooked in a conventional oven. The packaging of the roasts can provide duplicate cooking instructions for cooking roasts of duplicate weights in conventional ovens.

Although a preferred embodiment of the invention has been disclosed in detail herein, it will be obvious to those skilled in the art that variations and modifications of the disclosed embodiment can be made without departing from the spirit and scope of the invention as set forth in the following claims.

I claim:

1. A poultry roast, comprising:
a deboned poultry breast having poultry meat free of bones and an outer surface substantially covered with skin and an inner surface free of skin,
said breast including an elongated skeletal recess formed in said inner surface, and opposed breast halves extending on opposite sides of said skeletal recess,
at least one elongated tender positioned on said inner surface in juxtaposition with and parallel to said skeletal recess,
said opposed breast halves wrapped about said tender with said skin facing away from said tender,
a girdle extending about said wrapped breast maintaining said breast wrapped about said tender and with said skin facing away from said tender.

2. The poultry roast of claim 1, wherein
said opposed breast halves are spirally wrapped about said tender.

3. The poultry roast of claim 1, wherein
said girdle extending about said wrapped breast comprises a tubular net extending about said breast and gathered in a closed configuration at opposite ends of said breast.

4. The poultry roast of claim 3, wherein
said net engages said skin of said breast and gathers the skin of the breast about the poultry meat.

5. The poultry roast of claim 1, wherein
said tender is tapered along its length with one end thicker than the other end,
said breast is tapered along its skeletal recess with one end thinner than the other end,
said tender is positioned with its thicker end placed adjacent the thinner end of said breast.

6. The poultry roast of claim 1, wherein
said girdle extending about said wrapped breast comprises a tubular net twisted at its ends to close the net at its ends, and
said net having been treated with vegetable oil so that the net is easily removed from about the breast after the poultry roast has been cooked.

7. The poultry roast of claim 1, wherein
said at least one tender is selected from a group of tenders of different weights,
the selected tender has a weight that complements the weight of the poultry breast so that the total weight of the poultry roast is approximately equal to a predetermined total weight.

8. A plurality of poultry roasts each comprising a roast as described in claim 1, and said plurality of poultry roasts being of approximately the same weight for cooking at the same temperature for the same period.

9. The poultry roast of claim 1, wherein
said roast is baked until said skin is crusty and said meat beneath said skin is moist and tender.

10. A poultry roast, comprising:
a deboned poultry breast having an outer surface covered with skin and an inner surface free of skin,
at least one tender positioned adjacent said inner surface,
said breast wrapped about said tender,
and a girdle engaging said skin and holding said breast wrapped about said tender.

11. The poultry roast of claim 10, wherein
said girdle is a tubular receptacle.

12. The poultry roast of claim 10, wherein
said girdle is a net.

13. The poultry roast of claim 10, wherein
said tender is of a weight that complements the weight of the breast to reach a predetermined weight.

14. The poultry roast of claim 10, wherein
said tender comprises at least two tenders of a cumulative weight that complements the weight of the breast to reach a predetermined weight.

15. A plurality of poultry roasts each comprising a poultry roast as described in claim 10, and said plurality of poultry roasts being of approximately the same weight for cooking at the same temperature for the same period.

16. A method of forming a poultry roast, comprising:
forming a deboned poultry breast with an outer surface covered with skin and an inner surface free of skin,
placing at least one poultry tender on the inner surface of the poultry breast,
wrapping the breast about the poultry tender with the skin of the poultry breast facing away from the tender and the skin of the poultry breast substantially covering the outside of the poultry breast,
placing a girdle about the wrapped poultry breast, and
holding the poultry breast wrapped about the tenders with the girdle.

17. The method of claim 16, and further including the step of
selecting the poultry tender of a weight that complements the weight of the poultry breast to substantially equal a predetermined weight.

18. The method of claim 16, and further including the step of
selecting at least two tenders of a cumulative weight that complements the weight of the breast to approximately equal a predetermined weight.

19. The method of claim 16, and further including the step of
applying seasoning to the inner surface of the poultry breast.

20. The method of claim 16, and further including
the poultry breast having a skeletal recess, and the step of placing at least one poultry tender on the inner surface of the breast comprises placing an elongated poultry tender on the breast with the length of the tender extending parallel to the skeletal recess.

21. The method of claim 20, wherein the step of placing an elongated poultry tender on the breast comprises
reducing the size of the poultry tender and placing the reduced size poultry tender on the inner surface of the poultry breast.

22. The method of claim 21, wherein the step of reducing the size of the elongated poultry tender comprises cutting the poultry tender along its length.

23. A poultry roast, comprising:
a deboned poultry breast having breast meat with opposed inner and outer surfaces, said outer surface of said breast meat covered with skin and an inner surface of said breast meat free of skin,
at least one edible item positioned adjacent said inner surface of said breast meat,
said poultry breast wrapped about said edible item with said inner surface of said breast meat surrounding most of said edible item, and said skin surrounding most of said poultry breast and said edible item, and
a girdle engaging said skin and holding said breast wrapped about said edible item 10 and said skin about said breast.

24. A package containing a plurality of poultry roasts of claim 23, each said roast being of substantially equal weight so that identical cooking instructions can be used for all the poultry roasts in said package.

25. The poultry roast of claim 23, wherein said girdle comprises a net previously soaked in a liquid.

26. The poultry roast of claim 23, wherein said edible item is of sufficient breadth to enlarge the breadth of said poultry roast.

27. A package of poultry roasts, each said poultry roast being of substantially equal weight to facilitate cooking said roasts for the same length of time in a microwave oven, and instructions carried by said package for cooking said poultry roasts.

28. The package of poultry roasts of claim 24, wherein
said roasts each are prepared with deboned poultry breasts surrounding an edible food product,
the skin of the poultry breast forming an envelop that surrounds the outer surfaces of the breast, and
a girdle surrounding said skin and holding the poultry breast in position about the edible food product.

29. The package of poultry roasts of claim 28, wherein said edible food product of each poultry roast is selected of a weight that supplements the weight of the poultry breast of the poultry roast to achieve a predetermined cumulative weight desired for the poultry roast.

30. The package of poultry roasts of claim 29, wherein said edible food product of said poultry roasts comprises chicken tenders.
